(19) United States
(12) Patent Application Publication
(10) Pub. No.: US 2019/0300394 A1
(43) Pub. Date: Oct. 3, 2019

(54) DESALINATION SYSTEM

(71) Applicant: HITACHI, LTD., Tokyo (JP)

(72) Inventors: Hiroki MIYAKAWA, Tokyo (JP); Kotaro KITAMURA, Tokyo (JP); Masayuki MATSUURA, Tokyo (JP); Takanori OSHIKIRI, Tokyo (JP); Yusuke OKAWA, Tokyo (JP)

(21) Appl. No.: 16/288,254

(22) Filed: Feb. 28, 2019

(30) Foreign Application Priority Data
Mar. 29, 2018 (JP) 2018-064320

(51) Int. Cl. C02F 1/44

(52) U.S. Cl. CPC C02F 1/441; C02F 2201/002; C02F 2103/08; C02F 2209/003; C02F 2301/04; C02F 2209/03

(57) ABSTRACT

A desalination system includes: a pressurized vessel which generates concentrate water and permeate water by causing treatment target water to pass through a reverse osmosis membrane element built in the pressurized vessel; an energy recovery device which is located on a discharge channel so as to discharge the permeate water, and recovers energy of the permeate water; a bypass discharge channel which branches off from the discharge channel and is located between the pressurized vessel and the energy recovery device, and which discharges the permeate water; and a bypass control mechanism which is located on the bypass discharge channel and controls a discharge volume of the permeate water.

### BACKGROUND OF THE INVENTION

### 1. Field of the Invention

The present invention relates to a desalination system (a desalination treatment system).

### 2. Description of the Related Art

There have been desalination systems (desalination treatment systems) to subject saline treatment target water (feed water) to a reverse osmosis treatment (a desalination treatment) by using a reverse osmosis membrane element, and thus to generate permeate water (reverse osmosis treated water) and concentrate water. A typical desalination system has a structure in which reverse osmosis membrane elements are arranged in series inside a pressurized vessel formed into a cylindrical shape, for instance. The reverse osmosis membrane elements are connected to one another through water collection piping located at the center of the reverse osmosis membrane elements. The pressurized vessel has a structure that branches off into three directions, namely, a feed water side (an inlet side for the feed water), a permeate water side (an outlet side for the permeate water), and a concentrate water side (an outlet side for the concentrate water).

In the desalination system, the treatment target water (the feed water) is pressurized by using a high pressure pump and fed to the pressurized vessel in order to take advantage of a reverse osmotic pressure in each reverse osmosis membrane element. Here, the high pressure pump applies a pressure to the treatment target water (the feed water) in accordance with an aperture of a flow control valve installed on the concentrate water side of the pressurized vessel.

When the pressure applied to the treatment target water (the feed water) surpasses an osmotic pressure intrinsic to each reverse osmosis membrane element, desalinated water (the permeate water) passes through the reverse osmosis membrane element and flows into the water collection piping at the center in the pressurized vessel. Then, the desalinated water (the permeate water) is discharged from the permeate water side (the outlet side for the permeate water) to the outside of the pressurized vessel. Meanwhile, a saline concentration of the concentrate water is gradually increased from the feed water side to the concentrate water side around the water collection piping in the pressurized vessel. Then, the concentrate water is discharged from the concentrate water side (the outlet side for the concentrate water) to the outside of the pressurized vessel. The above-described pressure in the pressurized vessel is determined ultimately by the saline concentration at a final stage, an amount of the permeate water, and a flow velocity of the treatment target water (the feed water) passing through a membrane surface of the reverse osmosis membrane element.

In the desalination system, a relatively large pressure is applied to the feed water side of the pressurized vessel, whereby the amount of the permeate water can be increased. On the other hand, unevenness in the amount of the permeate water that passes through the pressurized vessel may lead to an increase in required power or develop contamination of the reverse osmosis membrane elements on the feed water side of the pressurized vessel.

For instance, in order to solve the aforementioned problems, Patent Literature 1 describes a seawater desalination system which includes a plug that blocks the water collection piping at a junction of reverse osmosis membrane elements at a central part in a pressurized vessel, and permeate water lines through which portions of permeate water separated fore and aft of the water collection piping blocked by the plug are discharged to the outside. In addition, Patent Literature 1 also describes the concept of regulating an amount of the portion of the permeate water on the inlet side in the pressurized vessel separated by the plug, and the concept of providing an energy recovery device to recover energy of the permeate water.

Meanwhile, Patent Literature 2 describes a system which includes a first pressurized vessel to conduct a primary treatment on treatment target water, a second pressurized vessel to conduct a secondary treatment on concentrate water treated in the primary treatment, a permeated water flow control valve to regulate a pressure in the first pressurized vessel, a first outlet pipe to discharge permeated water subjected to the primary treatment from the first pressurized vessel, and an energy recovery device provided between the first outlet pipe and the permeated water flow control valve.

### PRIOR ART DOCUMENT(S)

### Patent Literature(s)

Patent Literature 1: JP 2010-179264 A

Patent Literature 2: JP 2013-126636 A

### SUMMARY OF THE INVENTION

As described below, a conventional desalination system is desirably protected from application of a relatively large pressure to the permeate water side (the outlet side for the concentrate water) of the pressurized vessel, so that the system can use an isobaric energy recovery device that has a higher recovery ratio than that of a turbine energy recovery device.

This is due to the following reasons.

The isobaric energy recovery device is an apparatus which recovers energy stored in a fluid by introducing the fluid into a space in a pressure vessel and causing the fluid to change the volume of the space. Examples of the isobaric energy recovery device include a dual work energy exchanger (DWEER) energy recovery device and the like. Here, a description will be given on the assumption that the DWEER energy recovery device is hypothetically applied to a desalination system.

The DWEER energy recovery device includes pressure vessels. The inside of each pressure vessel is partitioned into two spaces with a piston (a partition member). A fluid from which energy is to be recovered (such as the permeate water after undergoing the reverse osmosis treatment in the desalination system) is introduced into one of the spaces in each pressure vessel. In the meantime, a fluid to be moved along with the energy recovery (such as the treatment target water before undergoing the reverse osmosis treatment in the desalination system) is introduced into the other space of each pressurized vessel. The DWEER energy recovery device has a structure to alternately repeat an operation to increase one of the spaces while reducing the other space and an operation to increase the other space while reducing the one space by switching flows of the respective fluids.

If the conventional desalination system uses the above-described isobaric energy recovery device, then the desalination system is structured to alternately switch a direction of flow of the permeate water and a direction of flow of the treatment target water. As a consequence, the conventional desalination system tends to leave a residual pressure in the piping or to cause suck back when the system is stopped. Due to the tendency of leaving the residual pressure in the piping or causing the suck back, the conventional desalination system may develop a negative pressure on the permeate water side of the pressurized vessel that has the reverse osmosis membrane elements built in. Here, the “suck back” means a phenomenon in which the permeate water moves from the permeate water side to the feed water side (the treatment target water side) through the reverse osmosis membrane elements built in the pressurized vessel due to the osmotic pressure.

The pressurized vessel is supposed to transfer the treatment target water from the feed water side to the permeate water side. The reverse osmosis membrane elements built in the pressurized vessel are not provided with very high resistance against the pressure applied to the permeate water side of the pressurized vessel. Accordingly, if a large pressure is applied to the permeate water side of the pressurized vessel, the reverse osmosis membrane elements may deteriorate their performance of the reverse osmosis treatment. Moreover, the conventional desalination system does not have a structure to suppress the development of the negative pressure on the permeate water side of the pressurized vessel, which is attributed to the residual pressure left in the piping or the occurrence of suck back when the system is stopped. For this reason, the conventional desalination system cannot use the isobaric energy recovery device that has a high recovery ratio.

On the other hand, the turbine energy recovery device has a lower recovery ratio than that of the isobaric energy recovery device, but does not adopt the structure to alternately switch the direction of flow of the permeate water and the direction of flow of the treatment target water. Unlike the DWEER energy recovery device, the above-described turbine energy recovery device is less likely to leave the residual pressure in the piping or cause suck back when the conventional desalination system is stopped. For this reason, the conventional desalination system has used the turbine energy recovery device that has the lower recovery ratio than that of the isobaric energy recovery device. Accordingly, it has been desired that the conventional desalination system should be protected from application of a relatively large pressure to the permeate water side of the pressurized vessel, so that the system can use the isobaric energy recovery device with a high recovery ratio.

The present invention has been made in order to solve the above-mentioned problem and an object thereof is to provide a desalination system which is protected from application of a relatively large pressure to a permeate water side of a pressurized vessel therein.

To attain the object, the present invention provides a desalination system including: a pressurized vessel which generates concentrate water and permeate water by causing treatment target water to pass through a reverse osmosis membrane element built in the pressurized vessel; an energy recovery device which is located on a discharge channel so as to discharge the permeate water, and recovers energy of the permeate water; a bypass discharge channel which branches off from the discharge channel and is located between the pressurized vessel and the energy recovery device, and which discharges the permeate water; and a bypass control mechanism which is located on the bypass discharge channel and controls a discharge volume of the permeate water.

Other features of the present invention will be described later.

According to the present invention, a desalination system can be protected from application of a relatively large pressure to a permeate water side of a pressurized vessel therein.

### BRIEF DESCRIPTION OF THE DRAWINGS

FIG. 1 is a schematic diagram showing a configuration of a desalination system according to a first embodiment;

FIG. 2 is an explanatory diagram showing an operation at the time of a start-up process of the desalination system of the first embodiment;

FIG. 3 is an explanatory diagram showing an operation at the time of an energy recovery process of the desalination system of the first embodiment;

FIG. 4 is a schematic diagram showing a configuration of a desalination system according to a second embodiment; and

FIG. 5 is a schematic diagram showing a configuration of a desalination system of a comparative example.

### DETAILED DESCRIPTION OF THE EMBODIMENTS

Modes to carry out the present invention (hereinafter referred to as “embodiments”) will be described below in detail with reference to the accompanying drawings. It is to be noted that each of the drawings is nothing more than schematic illustration of the present invention that helps full understanding of the present invention. In other words, the present invention shall not be limited to the illustrated examples. In the meantime, constituents that are common to the drawings or similar constituents in the drawings will be denoted by the same reference signs and overlapping explanations thereof will be omitted.

### First Embodiment

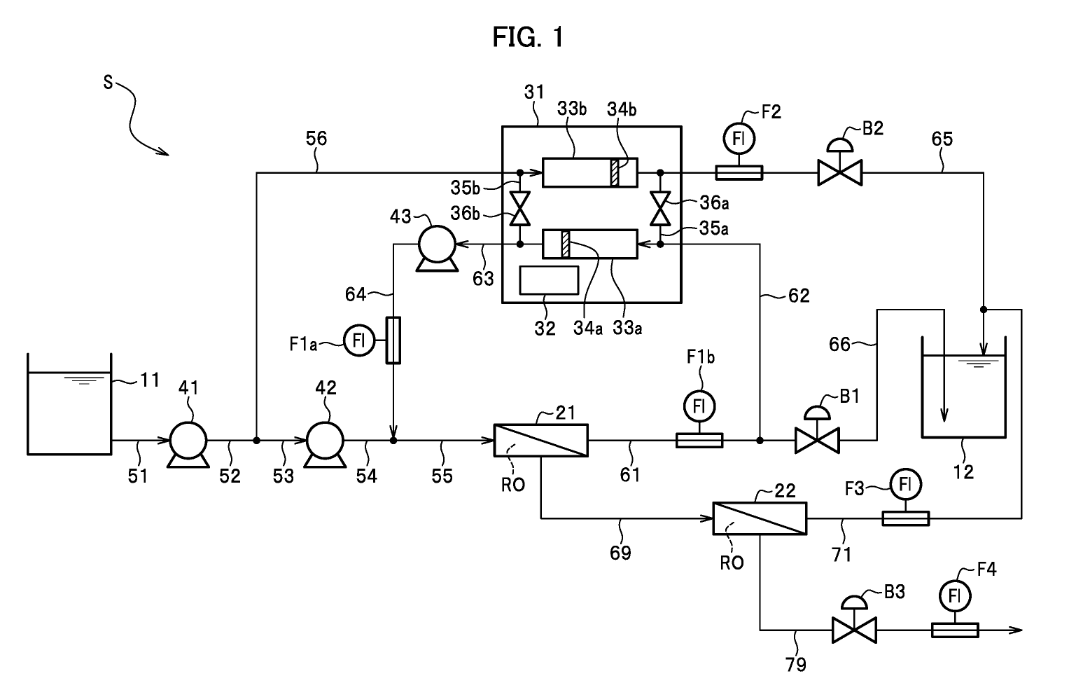

A first embodiment provides a desalination system S as described below (see FIG. 1):

(1) the desalination system S includes a bypass pipe 66 (a bypass discharge channel) located between a pressurized vessel 21 and an energy recovery device 31;

(2) the desalination system S includes a flow control valve B1 (a bypass control mechanism) on the bypass pipe 66; and

(3) the desalination system S applies an isobaric energy recovery device serving as the energy recovery device 31, which has a higher recovery ratio than that of a turbine energy recovery device.

<Configuration of Desalination System>

Now, a configuration of the desalination system S of the first embodiment will be described below with reference to FIG. 1. FIG. 1 is a schematic diagram showing a configuration of the desalination system S according to the first embodiment.

As shown in FIG. 1, the desalination system S includes a raw water tank 11, a treated water tank 12, pressurized vessels 21 and 22, the energy recovery device 31, a feed water pump 41, a high pressure pump 42, and a booster pump 43.

The raw water tank 11 is a tank that stores seawater (raw water) as treatment target water (feed water).

The treated water tank 12 is a tank that stores permeate water (reverse osmosis treated water).

Each of the pressurized vessels 21 and 22 is a reverse osmosis apparatus that subjects the saline treatment target water (the feed water) to a reverse osmosis treatment (a desalination treatment) while using a reverse osmosis membrane element RO provided with a reverse osmosis (RO) membrane, thereby generating the permeate water (the reverse osmosis treated water) and concentrate water. The pressurized vessel 21 is located upstream of the pressurized vessel 22 so as to conduct a primary treatment on the treatment target water. Meanwhile, the pressurized vessel 22 is located downstream of the pressurized vessel 21 so as to conduct a secondary treatment on the treatment target water. A configuration of the pressurized vessels 21 and 22 will be described later in the chapter “Configuration of pressurized vessels”.

The energy recovery device 31 is an apparatus which recovers energy of the permeate water (primary permeate water) generated in the pressurized vessel. A configuration of the energy recovery device 31 will be described later in the chapter “Configuration of energy recovery device”.

The feed water pump 41 is a pump which applies a pressure to the seawater (the raw water) in the raw water tank 11 and feeds the seawater to a downstream side.

The high pressure pump 42 is a pump which applies a pressure to the seawater (the raw water) fed from the feed water pump 41 and feeds the seawater to the downstream side as the treatment target water.

The booster pump 43 is a pump which further boosts the water (boost target water) discharged from the energy recovery device 31 and feeds the water to the downstream side as the treatment target water.

The desalination system S includes pipes 51, 52, 53, 54, 55, 56, 61, 62, 63, 64, 65, 66, 69, 71, 79 as constituents to transfer the water. Among them, a pipe that transfers the water discharged from a constituent on the upstream side to the downstream side may be referred to as an “outlet pipe” as appropriate. In the meantime, a pipe that introduces the water into a constituent on the downstream side may be referred to as an “inlet pipe” as appropriate.

The pipe 51 is located between the raw water tank 11 and the feed water pump 41. The pipe 51 feeds the untreated seawater (the raw water) from the raw water tank 11 to the feed water pump 41.

The pipe 52 and the pipe 53 are located between the feed water pump 41 and the high pressure pump 42, and are connected to each other. The pipe 52 is an outlet pipe that transfers the water discharged from the feed water pump 41 to the downstream side. The pipe 53 is an inlet pipe that introduces the water into the high pressure pump 42.

The pipe 54 and the pipe 55 are located between the high pressure pump 42 and the feed water side (the inlet side for the treatment target water) of the pressurized vessel 21, and are connected to each other. The pipe 54 is an outlet pipe that transfers the water discharged from the high pressure pump 42 to the downstream side. The pipe 55 is an inlet pipe that introduces the water into the pressurized vessel 21. The pipe 55 is connected to the feed water side (the inlet side for the treatment target water) of the pressurized vessel 21.

The pipe 56 that branches off from the pipe 52 is located between the feed water pump 41 and the energy recovery device 31. The pipe 56 is an inlet pipe that introduces the water discharged from the feed water pump 41 into the energy recovery device 31. The pipe 56 is connected to a low pressure side inlet for the treatment target water (the boost target water side) of the energy recovery device 31.

The pipe 61 and the pipe 62 are located between the pressurized vessel 21 and the energy recovery device 31, and are connected to each other. The pipe 61 is an outlet pipe that transfers the water discharged from the pressurized vessel 21 to the downstream side. The pipe 61 is connected to the permeate water side (the outlet side for the primary permeate water) of the pressurized vessel 21. The pipe 62 is an inlet pipe that introduces the water into the energy recovery device 31. The pipe 62 is connected to an upstream side inlet for the permeate water (the primary permeate water) of the energy recovery device 31. The pipe 61 and the pipe 62 as well as the pipe 65 collectively constitute a primary discharge channel to discharge the permeate water (the primary permeate water) generated in the pressurized vessel 21.

The pipe 63 is located between the energy recovery device 31 and the booster pump 43. The pipe 63 is an outlet pipe that transfers the water discharged from the energy recovery device 31 to the booster pump 43 on the downstream side. The pipe 63 is connected to a high pressure side inlet for the treatment target water (the boost target water) of the energy recovery device 31.

The pipe 64 is located between the booster pump 43 and the pipe 55. The pipe 64 is an outlet pipe that transfers the water (boosted water) discharged from the booster pump 43 to the pressurized vessel 21 on the downstream side through the pipe 55.

The pipe 65 is located between the energy recovery device 31 and the treated water tank 12. The pipe 65 is an outlet pipe that transfers the permeate water (reverse osmosis treated water), which is low pressure boosted water discharged from the energy recovery device 31 and boosted at a low pressure, to the treated water tank 12 on the downstream side. The pipe 65 is connected to a downstream side inlet for the permeate water (the primary permeate water) of the energy recovery device 31. An end portion of the pipe 65 is made openable so that the pipe 65 can release the pressure by opening a flow control valve B2 to be described later.

The pipe 66 that branches off from the pipe 61 is located between the pressurized vessel 21 and the treated water tank 12. The pipe 66 is an outlet pipe that transfers the permeate water (the reverse osmosis treated water), which is discharged from the pressurized vessel 21, off the pipe 61 to the treated water tank 12 while bypassing the energy recovery device 31. The pipe 66 may be hereinafter referred to as the “bypass pipe 66” as appropriate. An end portion (an end portion on the treated water tank 12 side) of the bypass pipe 66 is made openable so that the bypass pipe 66 can release the pressure by opening the flow control valve B1 to be described later. The end portion (the end portion on the treated water tank 12 side) of the bypass pipe 66 is located inside the treated water tank 12 and at a position lower than a liquid surface of the permeate water.

The pipe 69 is located between the pressurized vessel 21 and the pressurized vessel 22. The pipe 69 is an outlet pipe that transfers the permeate water, which is subjected to the primary treatment and discharged from the pressurized vessel 21, to the pressurized vessel 22 on the downstream side. The pipe 69 is connected to the concentrate water side (the outlet side for primary concentrate water) of the pressurized vessel 21 and the feed water side (the inlet side for the primary concentrate water) of the pressurized vessel 22.

The pipe 71 is located between the pressurized vessel 22 and the pipe 65. The pipe 71 is an outlet pipe that transfers the permeate water (the reverse osmosis treated water) discharged from the pressurized vessel 22 to the treated water tank 12 through the pipe 65. The pipe 71 is connected to the permeate water side (the outlet side for secondary permeate water) of the pressurized vessel 22. The pipe 71 and the pipe 65 collectively constitute a secondary discharge channel to discharge the permeate water (the secondary permeate water) generated in the pressurized vessel 22.

The pipe 79 is located on the concentrate water side (the outlet side for secondary concentrate water) of the pressurized vessel 22. The pipe 79 is an outlet pipe that transfers the concentrate water, which is subjected to the secondary treatment and discharged from the pressurized vessel 22, to the outside (such as the sea or a not-illustrated storage tank). The pipe 79 is connected to the concentrate water side (the outlet side for the secondary concentrate water) of the pressurized vessel 22. An end portion of the pipe 79 is made openable so that the pipe 79 can release the pressure by opening a flow control valve B3 to be described later.

The desalination system S includes flowmeters F1a, F1b, F2, F3, and F4 as constituents for measuring flow volumes of the water.

The flowmeter F1a is located on the path of the pipe 64 and measures a flow volume of the water flowing in the pipe 64.

The flowmeter F1b is located on the path of the pipe 61 and measures a flow volume of the water flowing in the pipe 61.

The flowmeter F2 is located on the path of the pipe 65 and between the energy recovery device 31 and the flow control valve B2 to be described later, and measures a flow volume of the water flowing in the pipe 65.

The flowmeter F3 is located on the path of the pipe 71 and measures a flow volume of the water flowing in the pipe 71.

The flowmeter F4 is located on the path of the pipe 79 and downstream of the flow control valve B3 to be described later, and measures a flow volume of the water flowing in the pipe 79.

The desalination system S includes the flow control valves B1, B2, and B3 as constituents for controlling the flow volumes of the water.

The flow control valve B1 is located on the path of the bypass pipe 66 and controls a flow volume of the water flowing in the bypass pipe 66. The flow control valve B1 functions as a bypass control mechanism on the bypass pipe 66 for controlling a discharge volume of the permeate water (the primary permeate water) generated in the pressurized vessel 21.

The flow control valve B2 is located on the path of the pipe 65 and controls a flow volume of the water flowing in the pipe 65. The flow control valve B2 functions as a control mechanism different from the flow control valve B1 (the bypass control mechanism) to control the discharge volume of the permeate water (the primary permeate water) generated in the pressurized vessel 21 and discharged through the energy recovery device 31. The flow control valve B2 can regulate a load to be applied to the energy recovery device 31 by controlling the flow volume of the water flowing in the pipe 65.

The flow control valve B3 is located on the path of the pipe 79 and controls a flow volume of the water flowing in the pipe 79. The flow control valve B3 functions as a control mechanism to control a discharge volume of the concentrate water (the secondary concentrate water) generated in the pressurized vessel 22.

In the above-described configuration, the pipe 55 for introducing the treatment target water is connected to one of end portions (the inlet) of the pressurized vessel 21. In the meantime, the pipe 61 for discharging the permeate water (the reverse osmosis treated water) and the pipe 69 for discharging the concentrate water subjected to the primary treatment are connected to the other end portion (the outlet) of the pressurized vessel 21. The pressurized vessel 21 functions as a first pressurized vessel to generate the primary concentrate water and the primary permeate water by subjecting the treatment target water to the primary treatment by using the built-in reverse osmosis membrane element RO.

On the other hand, the pipe 69 for introducing the concentrate water as the treatment target water, which is subjected to the primary treatment in the pressurized vessel 21, is connected to one of end portions (the inlet) of the pressurized vessel 22. In the meantime, the pipe 71 for discharging the permeate water (the reverse osmosis treated water) and the pipe 79 for discharging the concentrate water subjected to the secondary treatment are connected to the other end portion (the outlet) of the pressurized vessel 22. The pressurized vessel 22 functions as a second pressurized vessel to generate the secondary concentrate water and the secondary permeate water by subjecting the primary concentrate water to the secondary treatment by using the built-in reverse osmosis membrane element RO.

Meanwhile, in the above-described configuration, the pipe 61, the pipe 62, and the pipe 65 collectively constitute the primary discharge channel to discharge the permeate water (the primary permeate water) generated in the pressurized vessel 21. On the other hand, the pipe 71 and the pipe 65 collectively constitute the secondary discharge channel to discharge the permeate water (the secondary permeate water) generated in the pressurized vessel 22. Moreover, the bypass pipe 66 branches off from the aforementioned primary discharge channel and is located between the pressurized vessel 21 and the energy recovery device 31. The bypass pipe 66 functions as the bypass discharge channel to transfer the permeate water generated in the pressurized vessel 21 off the primary discharge channel and to the treated water tank 12 while bypassing the energy recovery device 31. The flow control valve B1 that functions as the bypass control mechanism is located on the bypass pipe 66.

<Configuration of Pressurized Vessels>

Each of the pressurized vessels 21 and 22 described above is formed into a cylindrical shape, for example, and has a structure in which the reverse osmosis membrane elements RO are arranged in series in the inside. The respective reverse osmosis membrane elements RO are connected to one another through water collection piping (not shown) located at the center of the reverse osmosis membrane elements RO. Nonetheless, the pressurized vessel 21 or 22 may instead have a structure provided with only one reverse osmosis membrane element RO.

Each of the pressurized vessels 21 and 22 has a structure that branches off in three directions, namely, the feed water side, the permeate water side, and the concentrate water side. The feed water side is the inlet side to which the treatment target water (the feed water) is fed. The permeate water side is the outlet side from which the permeate water (the reverse osmosis treated water) generated in the reverse osmosis treatment is discharged. The concentrate water side is the outlet side from which the concentrate water generated in the reverse osmosis treatment is discharged. The pressurized vessel 21 is located upstream of the pressurized vessel 22. The pressurized vessel 21 uses the seawater (the raw water) as the treatment target water (the feed water), and generates the permeate water (the primary permeate water) and the concentrate water (the primary concentrate water) from the treatment target water (the feed water). The pressurized vessel 22 uses the primary concentrate water generated in the pressurized vessel 21 as the treatment target water (the feed water), and generates the permeate water (the secondary permeate water) and the concentrate water (the secondary concentrate water), which is concentrated more, from the treatment target water (the feed water).

In the desalination system S, the treatment target water (the feed water) is pressurized by using the high pressure pump 42 and fed to the pressurized vessel 21 in order to take advantage of a reverse osmotic pressure in the reverse osmosis membrane elements RO. In this instance, the high pressure pump 42 applies a pressure to the treatment target water (the feed water) in accordance with a measurement value with the flowmeter F1b and a measurement value with the flowmeter F3.

When the pressure applied to the treatment target water (the feed water) surpasses the osmotic pressure intrinsic to each reverse osmosis membrane element RO in the pressurized vessel 21, desalinated water (the permeate water) passes through the reverse osmosis membrane element RO and flows into the water collection piping (not shown) at the center in the pressurized vessel 21. Then, the desalinated water (the permeate water) is discharged from the permeate water side (the outlet side for the permeate water) to the outside of the pressurized vessel 21. Meanwhile, a saline concentration of the concentrate water is gradually increased from the feed water side to the concentrate water side around the water collection piping (not shown) in the pressurized vessel 21. Then, the concentrate water is discharged from the concentrate water side (the outlet side for the concentrate water) to the outside of the pressurized vessel 21. The above-described pressure in the pressurized vessel 21 is determined ultimately by the saline concentration at a final stage, an amount of the permeate water, and a flow velocity of the treatment target water (the feed water) that passes through a membrane surface of the reverse osmosis membrane element RO.

<Configuration of Energy Recovery Device>

In this embodiment, the energy recovery device 31 is formed from an isobaric energy recovery device (a reciprocating isobaric energy recovery device) having a high recovery ratio. Examples of the isobaric energy recovery device (the reciprocating isobaric energy recovery device) include a DWEER energy recovery device and the like. Here, a description will be made assuming that the energy recovery device 31 is formed from the DWEER energy recovery device.

As shown in FIG. 1, the energy recovery device 31 formed from the DWEER energy recovery device includes a plurality (two in the illustrated example) of cylindrical pressure vessels 33a and 33b. The inside of each of the pressure vessels 33a and 33b is partitioned into two spaces with a piston 34a or 34b serving as a partition member. A fluid targeted for energy recovery (which is the permeate water discharged from the pressurized vessel 21 in the illustrated example) is introduced into one of the spaces (which is the space on the right side in the illustrated example) in each of the pressure vessels 33a and 33b. In the meantime, a fluid to be moved along with the energy recovery (which is the treatment target water fed from the feed water pump 41 in the illustrated example) is introduced into the other space (which is the space on the left side in the illustrated example) in each of the pressure vessels 33a and 33b.

The pipe on one end side (the permeate water side) of the pressure vessel 33a is connected to the pipe on one end side (the permeate water side) of the pressure vessel 33b with a pipe 35a. Meanwhile, the pipe on the other end side (the treatment target water (the boost target water) side) of the pressure vessel 33a is connected to the pipe on the other end side (the treatment target water (the boost target water) side) of the pressure vessel 33b with a pipe 35b. A switch unit 36a for switching a direction of flow of the water is located on the path of the pipe 35a. Likewise, a switch unit 36b for switching a direction of flow of the water is located on the path of the pipe 35b.

The energy recovery device 31 alternately repeats an operation to increase the one space (which is the space on the right side in the illustrated example) of each of the pressure vessels 33a and 33b while reducing the other space (which is the space on the left side in the illustrated example) thereof and an operation to increase the other space (which is the space on the left side in the illustrated example) while reducing the one space (which is the space on the right side in the illustrated example) by switching the flows of the permeate water and the treatment target water using the switch units 36a and 36b.

The energy recovery device 31 reciprocates the pistons 34a and 34b by alternately switching the direction of flow of the permeate water and the direction of flow of the treatment target water while controlling actions of the switch units 36a and 36b with a control device 32. Thus, the energy recovery device 31 can recover a residual pressure (a back pressure) remaining in the permeate water as energy.

<Operations of Desalination System>

(Operation at Time of Start-Up Process)

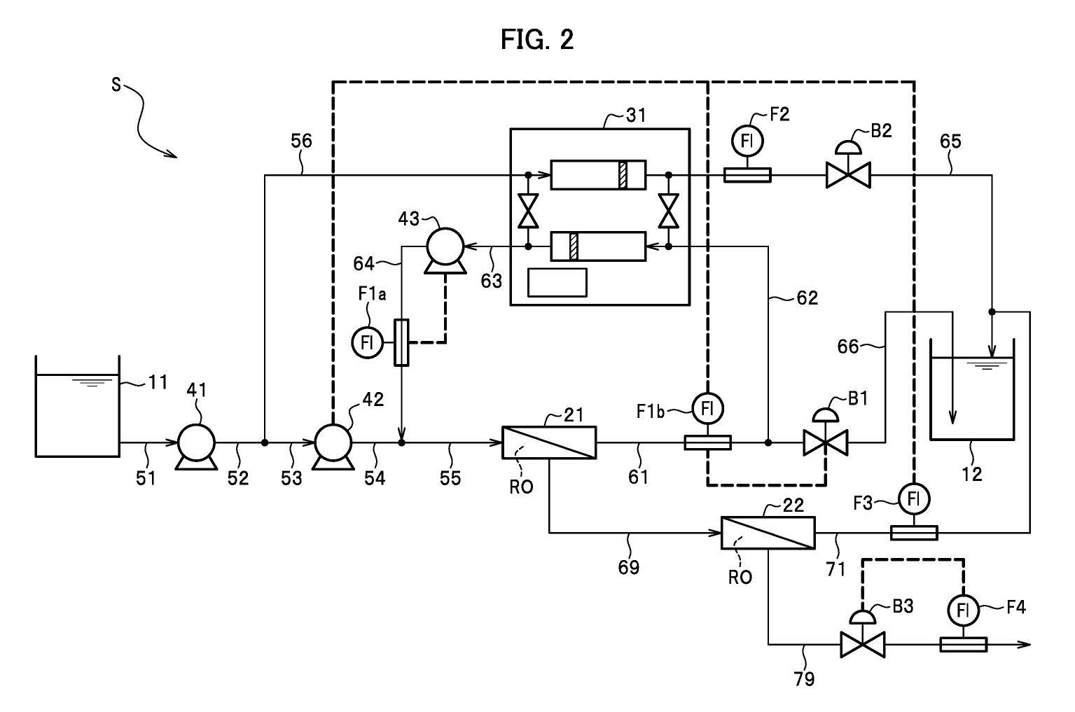

An operation at the time of a start-up process of the desalination system S will be described below with reference to FIG. 2. FIG. 2 is an explanatory diagram showing the operation at the time of the start-up process of the desalination system S. The operation of the desalination system S is controlled by a not-illustrated control unit.

In the desalination system S before the start-up process, the feed water pump 41, the high pressure pump 42, and the booster pump 43 are stopped. Meanwhile, the flow control valve B1 is fully open while the flow control valve B2 is fully closed. Note that the flow control valve B3 is in a given state depending on the operation.

At the time of the start-up process, the desalination system S starts the feed water pump 41 first, and then starts the booster pump 43. In this instance, the desalination system. S maintains the open state (the fully open state) of the flow control valve B1 and maintains the closed state (the fully closed state) of the flow control valve B2. Meanwhile, the desalination system S controls an aperture of the flow control valve B3 depending on the operation.

As indicated with dashed lines in FIG. 2, after starting the feed water pump 41 and the booster pump 43, the desalination system S controls a pressure in the booster pump 43 in accordance with a measurement value with the flowmeter F1a. Meanwhile, the desalination system S controls the aperture of the flow control valve B3 in accordance with a measurement value with the flowmeter F4.

Next, the desalination system S starts the high pressure pump 42. In this instance, as indicated with the dashed lines in FIG. 2, the desalination system S controls a pressure in the high pressure pump 42 in accordance with the measurement value with the flowmeter F1b and the measurement value with the flowmeter F3.

Next, after starting the high pressure pump 42, the desalination system S starts control of an aperture of the flow control valve B1. In this instance, as indicated with the dashed lines in FIG. 2, the desalination system S controls the aperture of the flow control valve B1 in accordance with the measurement value with the flowmeter F1b.

The start-up process of the desalination system S is carried out as described above. After the start-up process took place, the operation of the desalination system S proceeds to an energy recovery process (an operation process).

(Operation at Time of Energy Recovery Process)

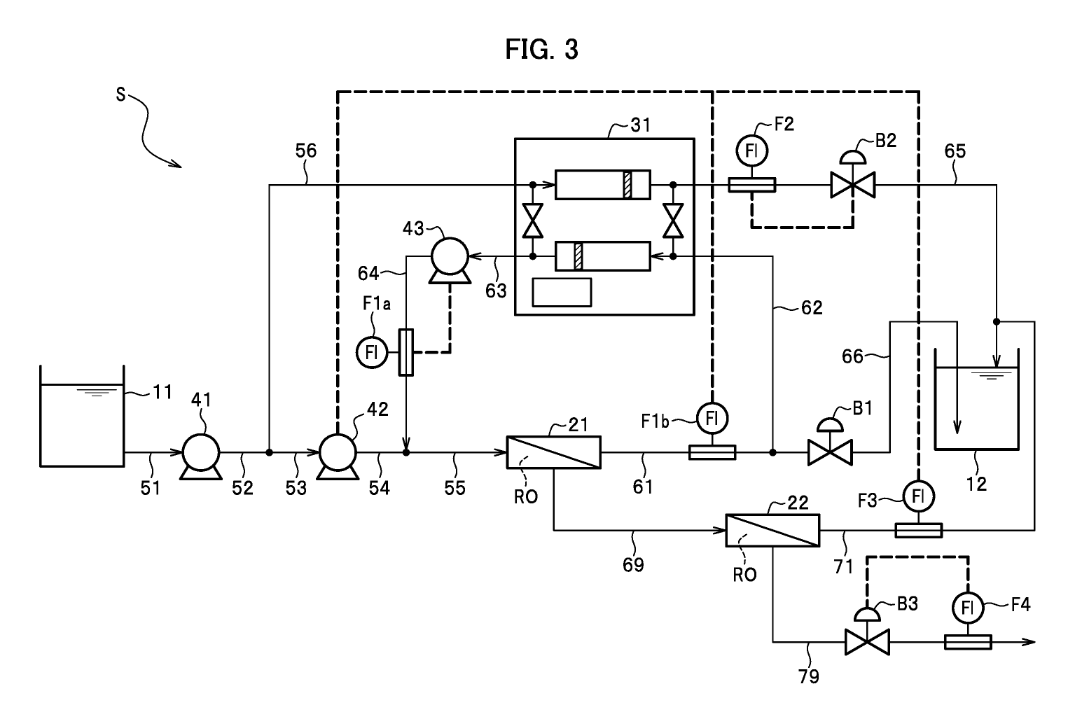

An operation at the time of the energy recovery process (the operation process) of the desalination system S will be described below with reference to FIG. 3. FIG. 3 is an explanatory diagram showing the operation at the time of the energy recovery process of the desalination system S.

The start-up process and the energy recovery process are mainly different in that the flow control valve B1 is closed and the flow control valve B2 is opened in the energy recovery process.

In the state immediately before starting the energy recovery process, the feed water pump 41, the booster pump 43, and the high pressure pump 42 are active in the desalination system S. Meanwhile, the flow control valves B1 and B3 are open while the flow control valve B2 is fully closed in the desalination system S.

At the time of the energy recovery process (the operation process), the desalination system S starts driving the energy recovery device 31 first and then closes the flow control valve B1. In this instance, the desalination system S gradually reduces the aperture of the flow control valve B1 until the aperture eventually turns to zero (full closure). However, depending on the operation, the flow control valve B1 may be slightly opened in order to control the flow volume of the permeate water (the primary permeate water) to be introduced into the energy recovery device 31 at the time of the energy recovery process (the operation process).

Next, the desalination system S opens the flow control valve B2 and starts control of an aperture of the flow control valve B2. In this instance, as indicated with dashed lines in FIG. 3, the desalination system S controls the aperture of the flow control valve B2 in accordance with a measurement value with the flowmeter F2. Moreover, at this time, the desalination system S controls pressures in the high pressure pump 42 and the booster pump 43 following the start-up process. In this instance, as indicated with the dashed lines in FIG. 3, the desalination system S controls the pressure in the high pressure pump 42 in accordance with the measurement value with the flowmeter F1b and the measurement value with the flowmeter F3. In this case, the desalination system S preferably controls the pressure in the high pressure pump 42 such that the measurement value with the flowmeter F1b and the measurement value with the flowmeter F3 remain stable at given values. In the meantime, the desalination system S controls the pressure in the booster pump 43 in accordance with the measurement value with the flowmeter F1a. Meanwhile, the desalination system S controls the aperture of the flow control valve B3 in accordance with the measurement value with the flowmeter F4.

Here, by locating the flowmeter F1b on the pipe 61 (the outlet pipe), the desalination system S can use the measurement value with the flowmeter F1b for controlling the high pressure pump 42 and the flow control valve B2. Thus, the desalination system S can favorably control the high pressure pump 42 and the flow control valve B2 such that the desalination system S is protected from application of a relatively large pressure to the permeate water side of the pressurized vessel 21 even in the case of using the isobaric energy recovery device 31. Moreover, by locating the flowmeter F1b in the pipe 61 (the outlet pipe), the desalination system S can use the measurement value with the flowmeter F1b for controlling the high pressure pump 42 both at the time of the start-up process and at the time of the energy recovery process.

(Operation at Time of Stopping Process)

An operation at the time of a stopping process of the desalination system S will be described below. The operation at the time of the stopping process of the desalination system S is conducted in the reverse order of the energy recovery process (see FIG. 3) and the start-up process (see FIG. 2).

In the state immediately before starting the stopping process, the feed water pump 41, the booster pump 43, and the high pressure pump 42 are active in the desalination system S. Meanwhile, the flow control valve B1 is fully closed while the flow control valves B2 and B3 are open in the desalination system S.

At the time of the stopping process, the desalination system S opens the flow control valve B1 first in order to reduce a negative pressure to be applied to the permeate water side of the pressurized vessel 21. In this instance, it is preferable that the desalination system S gradually increase the aperture of the flow control valve B1 until the flow control valve B1 is fully opened. Moreover, the desalination system S closes the flow control valve B2 substantially at the same timing so as to fully close the flow control valve B2 in preparation for the next start-up process. Meanwhile, the desalination system S controls the aperture of the flow control valve B3 depending on the operation.

Next, the desalination system S stops the energy recovery device 31 after a lapse of a predetermined time period since the flow control valve B1 was opened. Thereafter, the desalination system S stops the high pressure pump 42, the booster pump 43, and the feed water pump 41 in this order.

As a consequence, after the stopping process, the feed water pump 41, the high pressure pump 42, and the booster pump 43 are stopped in the desalination system S. In the meantime, the flow control valve B1 is fully open while the flow control valve B2 is fully closed. Here, the flow control valve B3 is in the given state depending on the operation.

<Main Characteristics of Desalination System>

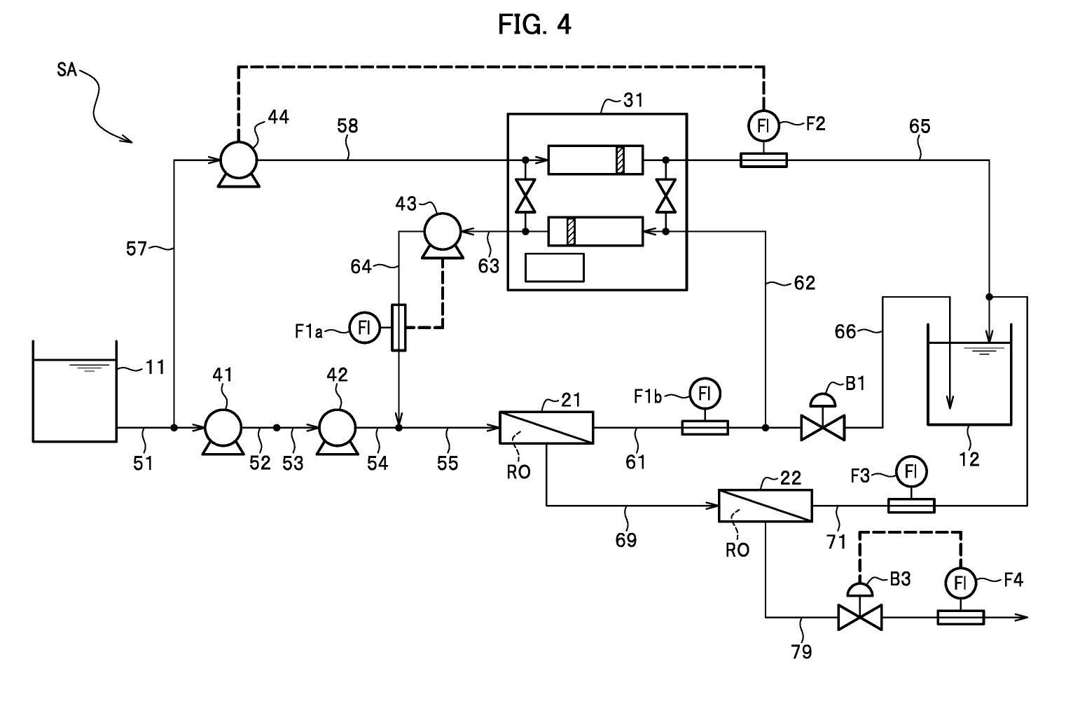

Main characteristics of the desalination system S according to the first embodiment will be described below. Here, in order to provide a clear description of the characteristics of the desalination system S according to the first embodiment, a configuration and main characteristics of a desalination system SZ of a comparative example will be described and then the main characteristics of the desalination system S according to the first embodiment will be described. Note that FIG. 4 will be used later for description of a second embodiment.

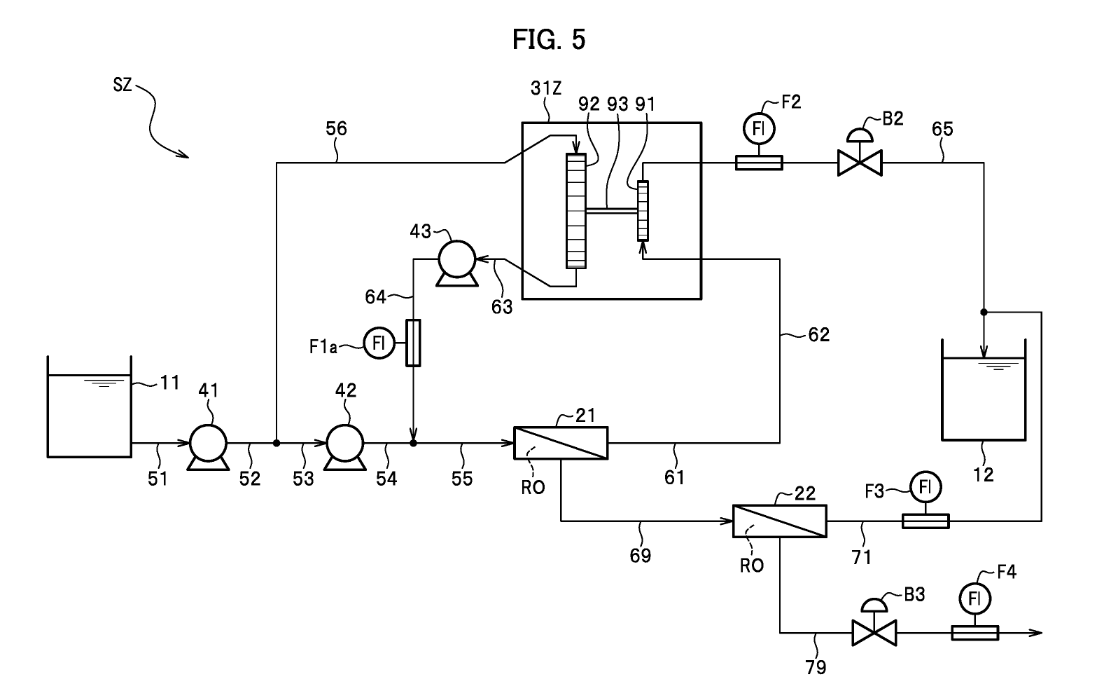

FIG. 5 is a schematic diagram showing the configuration of the desalination system SZ of the comparative example. The desalination system SZ of the comparative example is a system which includes a turbine energy recovery device 31Z instead of the isobaric energy recovery device 31.

Here, a configuration of the turbine energy recovery device 31Z will be described. In the example shown in FIG. 5, the turbine energy recovery device 31Z includes a first turbine 91, a second turbine 92, and a shaft 93 that connects the first turbine 91 to the second turbine 92. The second turbine 92 has a larger diameter than a diameter of the first turbine 91.

The desalination system SZ of the comparative example introduces the permeate water generated in the pressurized vessel 21 into the first turbine 91 of the turbine energy recovery device 31Z. Then, the permeate water having passed through the first turbine 91 via the pipe 65 is discharged to the treated water tank 12. Meanwhile, the desalination system SZ of the comparative example introduces the seawater (the raw water) pressurized with the feed water pump 41 as the treatment target water into the second turbine 92 of the turbine energy recovery device 31Z. In this case, the treatment target water is introduced into the second turbine 92 such that a direction of rotation of the first turbine 91 by the permeate water becomes an opposite direction to a direction of rotation of the second turbine 92 by the treatment target water. Thereafter, the desalination system SZ of the comparative example discharges the treatment target water having passed through the second turbine 92 to the booster pump 43 side. Here, the pressure of the permeate water to be introduced into the first turbine 91 is pressurized with the high pressure pump 42 and is therefore higher than the pressure of the treatment target water to be introduced into the second turbine 92.

Unlike the isobaric energy recovery device 31 (see FIG. 1), the turbine energy recovery device 31Z does not alternately switch the direction of flow of the permeate water and the direction of flow of the treatment target water. For this reason, it is possible to restrain the desalination system SZ of the comparative example, which uses the turbine energy recovery device 31Z, from leaving a residual pressure in the pipes or increasing the chance of occurrence of suck back when the system is stopped. Nonetheless, the turbine energy recovery device 31Z has a lower recovery ratio than that of the isobaric energy recovery device 31 (see FIG. 1). As a consequence, the turbine energy recovery device 31Z discharges the permeate water that contains a lot of the residual pressure (back pressure) energy to the downstream side.

(Differences Between Comparative Example and Embodiment)

When the above-described desalination system SZ of the comparative example provided with the turbine energy recovery device 31Z is compared with the desalination system S according to the first embodiment, these desalination systems are different from each other in the following aspects:

(1) the desalination system SZ of the comparative example does not include the bypass pipe 66 (see FIG. 1);

(2) the desalination system SZ of the comparative example does not include the flow control valve B1 (see FIG. 1); and

(3) as mentioned above, the desalination system SZ of the comparative example includes the turbine energy recovery device 31Z (see FIG. 5) instead of the isobaric energy recovery device 31 (see FIG. 1) that is formed from the DWEER energy recovery device.

Regarding the difference (1) mentioned above, the desalination system SZ of the comparative example does not include the bypass pipe 66 unlike the first embodiment. For this reason, the desalination system SZ of the comparative example cannot discharge the permeate water generated in the pressurized vessel 21 to the treated water tank 12 while branching off from the pipes 61 and 62 (the discharge channel from the pressurized vessel 21).

On the other hand, the desalination system S according to the first embodiment includes the bypass pipe 66 (the bypass discharge channel) located between the pressurized vessel 21 and the energy recovery device 31. In this way, the desalination system S according to the first embodiment can discharge the permeate water generated in the pressurized vessel 21 to the treated water tank 12 while branching off from the pipes 61 and 62 (the discharge channel from the pressurized vessel 21).

Meanwhile, regarding the differences (2) and (3) mentioned above, the desalination system SZ of the comparative example does not include the flow control valve B1 (see FIG. 1) as provided in the first embodiment. For this reason, the desalination system SZ of the comparative example cannot control the volumes of the permeate water flowing in the pipes 61 and 62 (the discharge channel from the pressurized vessel 21) or the pressures in the pipes 61 and 62.

The above-described desalination system SZ of the comparative example cannot be protected from application of a relatively large pressure to the permeate water side of the pressurized vessel 21 when the system is stopped. The above-described desalination system SZ cannot suppress the development of the negative pressure on the permeate water side of the pressurized vessel 21, which is attributed to the residual pressure remaining in the pipes 61 and 62 (the discharge channel) or the occurrence of the suck back.

For this reason, if the desalination system SZ of the comparative example applies the isobaric energy recovery device 31 of the first embodiment, it is likely that the desalination system SZ deteriorates the performance of the reverse osmosis treatment by the reverse osmosis membrane element RO built in the pressurized vessel 21.

On the other hand, the desalination system S according to the first embodiment includes the flow control valve B1 (the bypass control mechanism). In this way, the desalination system S according to the first embodiment can control the discharge volume of the permeate water discharged through the bypass pipe 66 by using the flow control valve B1, thereby controlling the volumes of the permeate water flowing in the pipes 61 and 62 (the discharge channel from the pressurized vessel 21) as well as the pressures in the pipes 61 and 62.

The above-described desalination system S according to the first embodiment can be protected from application of a relatively large pressure to the permeate water side of the pressurized vessel 21 when the system is stopped. In other words, the above-described desalination system S according to the first embodiment can favorably control the permeate water that flows in the pipes 61 and 62 (the discharge channel from the pressurized vessel 21) depending on the respective operation processes. For example, the desalination system S can fully close the flow control valve B1 at the time of the energy recovery process and open the flow control valve B1 at the time of the start-up process and at the time of the stopping process on the other hand. The above-described desalination system S according to the first embodiment can suppress the development of the negative pressure on the permeate water side of the pressurized vessel 21 attributable to the residual pressure remaining in the pipes 61 and 62 (the discharge channel) or the occurrence of the suck back when the system is stopped.

Accordingly, the desalination system S of the first embodiment can suppress a deterioration in performance of the reverse osmosis treatment by the reverse osmosis membrane element RO built in the pressurized vessel 21 even though the desalination system. S applies the isobaric energy recovery device 31.

As a consequence, the isobaric energy recovery device 31 such as the DWEER energy recovery device, which has a higher recovery ratio than that of the turbine energy recovery device 31Z, is applicable to the energy recovery device 31 in the desalination system S of the first embodiment.

Here, as shown in FIG. 1, in the desalination system S according to the first embodiment, the end portion (the end portion on the treated water tank 12 side) of the bypass pipe 66 (the bypass discharge channel) is located inside the treated water tank 12 and at the position lower than the liquid surface of the permeate water. The desalination system S does not suck the air in at the time of the suck back. Accordingly, it is possible to simplify an air venting process when the system is restarted.

Meanwhile, as shown in FIG. 3, the desalination system S according to the first embodiment controls the aperture of the flow control valve B2 in accordance with the measurement value with the flowmeter F2, and controls the pressure in the high pressure pump 42 in accordance with the measurement value with the flowmeter F1b and the measurement value with the flowmeter F3 at the time of the energy recovery process. The above-described desalination system S can favorably control a pressure to be applied to the feed water side (the inlet side for the feed water) of the pressurized vessel 21 and a pressure to be applied to the permeate water side (the outlet side for the permeate water) thereof. As a consequence, the desalination system S can conduct the reverse osmosis treatment (the desalination treatment) at high efficiency with the pressurized vessel 21 while maintaining the performance of the reverse osmosis treatment by the reverse osmosis membrane element RO built in the pressurized vessel 21.

As described above, the desalination system S of the first embodiment can be protected from application of a relatively large pressure to the permeate water side of the pressurized vessel 21. The desalination system S can suppress the deterioration in performance of the reverse osmosis treatment by the reverse osmosis membrane element RO built in the pressurized vessel 21 even when the desalination system S applies the isobaric energy recovery device. Accordingly, the desalination system S can use the isobaric energy recovery device with a high recovery ratio such as the DWEER energy recovery device.

### Second Embodiment

A second embodiment provides a desalination system SA in which a feed water pump 44 that is different from the feed water pump 41 applies a pressure to the seawater (the raw water) and feeds the seawater to the energy recovery device 31 (see FIG. 4).

A configuration of the desalination system SA according to the second embodiment will be described below with reference to FIG. 4. FIG. 4 is a schematic diagram showing the configuration of the desalination system SA according to the second embodiment.

When the desalination system SA of the second embodiment is compared with the desalination system S according to the first embodiment (see FIG. 1), these desalination systems are different from each other in the following aspects as shown in FIG. 4:

(1) the desalination system SA is deprived of the pipe 56 (see FIG. 1) and instead provided with pipes 57 and 58, and the feed water pump 44 (another pump) different from the feed water pump 41 (the pump); and

(2) the desalination system SA is deprived of the flow control valve B2 (see FIG. 1).

The feed water pump 44 is located between the pipe 57 and the pipe 58. The pipe 57 that branches off from the pipe 51 (the inlet pipe) is located between the raw water tank 11 and the feed water pump 41. The pipe 58 is connected to the feed water pump 44 and the energy recovery device 31.

The above-mentioned feed water pump 41 is the pump which is located on the feed water side of the pressurized vessel 21 and applies a pressure to a portion of the treatment target water to be introduced into the pressurized vessel 21. On the other hand, the feed water pump 44 is a pump which is located between the feed water pump 41 and the energy recovery device 31 and applies a pressure to a portion of the treatment target water to be introduced into the energy recovery device 31.

The desalination system SA according to the second embodiment automatically starts the feed water pump 44 at the time of starting the system. Meanwhile, as indicated with dashed lines in FIG. 4, the desalination system SA controls the feed water pump 44 at the time of the energy recovery process such that a pressure in the feed water pump 44 is changed in accordance with the measurement value with the flowmeter F2.

The above-described desalination system S according to the first embodiment regulates the load to be applied to the energy recovery device 31 by controlling the flow volume of the water flowing in the pipe 65 with the flow control valve B2 (see FIG. 1). On the other hand, the desalination system SA according to the second embodiment regulates the load to be applied to the energy recovery device 31 by controlling the flow volumes of the water flowing in the pipes 57 and 58 with the feed water pump 44.

In this regard, a pump in general has such a structure that enables easier control of a flow of a relatively large amount of water than using a valve. In this context, the feed water pump 44 can easily control the flow of a relatively large amount of water in the relatively large desalination system SA as compared to the case of using the flow control valve B2 (see FIG. 1) in the first embodiment.

As with the desalination system S of the first embodiment, the desalination system SA according to the second embodiment can also be protected from application of a relatively large pressure to the permeate water side of the pressurized vessel 21.

In addition, the desalination system SA according to the second embodiment can easily control the flow of a relatively large amount of water as compared to the desalination system S of the first embodiment.

The present invention is not limited only to the above-described embodiments but also encompasses various modified examples. For example, the above-described embodiments are intended to describe the details in order to facilitate the understanding of the present invention. In this context, the present invention is not necessarily limited to the configuration that includes all the constituents described above. Meanwhile, part of the configurations of any of the embodiments may be replaced with other configurations, and such other configurations may be added to the configurations of the embodiments. In the meantime, each configuration in any of the embodiments can be subjected to addition of another configuration, deletion, and replacement with another configuration.

What is claimed is:

1. A desalination system comprising:
a pressurized vessel to generate concentrate water and permeate water by causing treatment target water to pass through a reverse osmosis membrane element built in the pressurized vessel;
an energy recovery device located on a discharge channel so as to discharge the permeate water, the energy recovery device recovers energy of the permeate water;
a bypass discharge channel branching off from the discharge channel and located between the pressurized vessel and the energy recovery device, the bypass discharge channel discharges the permeate water; and
a bypass control mechanism located on the bypass discharge channel so as to control a discharge volume of the permeate water.

2. The desalination system according to claim 1, wherein the energy recovery device is an isobaric energy recovery device.

3. The desalination system according to claim 1, further comprising:
a control mechanism different from the bypass control mechanism, the control mechanism controls a discharge volume of the permeated water generated in the pressurized vessel and discharged through the energy recovery device; and
a pump located on a feed water side of the pressurized vessel so as to apply a pressure to the treatment target water, wherein
at the time of stopping the desalination system, the desalination system opens the bypass control mechanism, closes the difference control mechanism, then stops the energy recovery device, and further stops the pump.

4. The desalination system according to claim 3, wherein
at the time of starting the desalination system, the desalination system drives the pump while maintaining an open state of the bypass control mechanism and maintaining a closed state of the different control mechanism, and
at the time of an energy recovery process, the desalination system starts driving the energy recovery device, then closes the bypass control mechanism, and opens the different control mechanism.

5. The desalination system according to claim 1, further comprising:
a first pump located on a feed water side of the pressurized vessel so as to apply a pressure to a portion of the treatment target water to be introduced into the pressurized vessel; and
a second pump located between the first pump and the energy recovery device so as to apply a pressure to a portion of the treatment target water to be introduced into the energy recovery device.

6. The desalination system according to claim 1, further comprising:
a treated water tank to store the permeate water, wherein
an end portion of the bypass discharge channel is located inside the treated water tank at a position lower than a liquid surface.
